(19) United States
(12) Patent Application Publication
(10) Pub. No.: US 2017/0343991 A1
(43) Pub. Date: Nov. 30, 2017

(54) Electronic Commissioning System for Production Facilities

(71) Applicant: Maverick Technologies Holdings, LLC, Columbia, IL (US)

(72) Inventors: Roy T. Green, Lexington, TN (US); Paul J. Galeski, Longboat Key, FL (US)

(21) Appl. No.: 15/604,262

(22) Filed: May 24, 2017

Related U.S. Application Data
(60) Provisional application No. 62/342,055, filed on May 26, 2016.

(51) Int. Cl. G05B 19/418

(52) U.S. Cl. CPC G05B 19/4183; G05B 2219/31304

(57) ABSTRACT

An improved commissioning system for production facilities includes a server storing information on all components included for commissioning the facility. Remote computing devices allow technicians to readily locate devices using satellite positioning information. Each component is given an identification tag with a unique identifier. After locating the components, the technician may use the remote devices to read the identification tag and communicate with the server to obtain and/or update information about the component. A commissioning manager may similarly access the server from a computing device to obtain real-time or near real-time information on the status of the commissioning process. With the real-time or near real-time information on the commissioning process, the commissioning manager can better direct the technicians' efforts and determine where bottlenecks in the commissioning process might be occurring.

### CROSS-REFERENCE TO RELATED APPLICATIONS

This application claims priority to U.S. provisional application Ser. No. 62/342,055, filed May 26, 2016 and titled Electronic Commissioning System for Production Facilities, the entire contents of which is incorporated herein by reference.

### BACKGROUND INFORMATION

The present invention relates to an electronic system for commissioning production facilities and for monitoring and controlling the commissioning process.

The startup and commissioning process for a production facility (such as a chemical plant) has historically been a laborious and extremely time intensive process. As is known, the production facility (such as a chemical plant) comprises equipment, such as reactors, boilers, columns, etc., each of which has a control loop. Each control loop includes components such as valves, sensors, etc. relevant to the particular piece of equipment. The typical commissioning procedure begins with manually assembling a loop folder for each instrument, device, and piece of equipment (hereafter, component) in each control loop of the production facility that must be tested/certified prior to startup of the facility. A loop folder contains all the information necessary to certify that a particular component is cleared for use in the facility. Depending on the component, a loop folder can include the following information:

instrument manufacturer's specification/data sheet,

piping and instrumentation diagram (P&ID),

loop diagram,

loop check test sheet/checklist,

instrument calibration certification,

plot plan/location diagram,

loop test procedure,

wiring diagrams/instructions,

control/function narrative,

alarm set point list,

construction completion certificate,

interlock diagram,

flow sizing sheet,

Certificate of Conformance (CoC),

Certificate of Origin (COE),

Material Test Report (MRT),

National Association of Corrosion Engineers (NACE) certificate, or

instrument configuration.

The step of generating the loop folders for each instrument and piece of equipment in the facility can take 6-12 weeks. Once the loop folders have been generated, commissioning of the facility can start. Commissioning includes the following steps for each component (in order):

pre-static inspection (to inspect the mechanical connections of the components),

static check (to inspect the electrical connections of the components),

pre-dynamic testing (to test component functions), and

final dynamic testing (to ensure system meets requirements).

However, before the inspections can start, each component in the facility must be flagged, so that the components can be found by the technicians who will inspect the components. Typically, streamers or flags are adhered to each item to make them easier to find.

When the technicians enter the facility to begin the inspection, each technician will take with them a number of loop folders. The technician will look for the component to which a particular loop folder pertains and run the necessary checks to certify the particular component is cleared for operation. It generally takes about 30 minutes to check a component, and typically, about one-half of this time is spent locating the component.

In the field, the technician does not have access to information regarding the commissioning status of the various components. Therefore, once the component is located, the technician may find that the component has not yet been mechanically or electrically connected, and thus is not ready, for example, for a pre-static inspection or a static check. Hence, the technician will have wasted the time locating a component which was not ready for the next inspection check.

Further, relying on loop folders invites inadvertent errors. In particular, the technician could inadvertently use an incorrect check list for a particular component. For example, the technician could accidentally check one control valve against the specifications (loop folder) for a different control valve.

Additionally, with a manual commissioning system, the commissioning manager cannot determine, in real-time or near real-time, the status of the commissioning project. The commissioning manager must wait until a shift is over to review the loop folders for the instruments that have been inspected and/or tested to then update a document charting the progress of the plant commissioning process. Thus, in a traditional commissioning project, the commissioning manager cannot easily identify if the technicians need to focus on a particular area of the facility (because other areas still require, for example, pre-static or static testing). Nor can the commissioning manager readily determine whether the commissioning project is ahead of, behind, or on schedule.

If a plant can produce product valued at $150,000/hour on a 24 hour/7 day a week operation basis, the plant effectively loses $3,600,000 per day that the plant is not functioning. Thus, it would be desirable to provide a commissioning system which can enable the commissioning manager to better follow the status of the commissioning process in real, or near-real, time so that the commissioning manager can better direct the technicians' efforts and determine where bottlenecks in the commissioning process might be occurring. Further, as can be appreciated, it would be beneficial to provide a system which would reduce the time involved in commissioning a plant or system within a plant.

### BRIEF DESCRIPTION

The subject matter disclosed herein describes an improved electronic commissioning system for production facilities. The improved commissioning system includes a server storing information on all components included for commissioning the facility. Remote devices, such as laptop or tablet computers, smartphones, or other mobile computing devices, allow technicians to readily locate devices using satellite positioning information. Each component is given an identification tag, such as a radio frequency identification (RFID) tag with a unique identifier. After locating the components, the technician may use the remote devices to read the identification tag and communicate with the server to obtain and/or update information about the component. Technicians may access any of the information stored on the server relating to a component via the remote device and update the status of the component from the remote device. A commissioning manager may similarly access the server from a computing device, such as a work station, desktop computer, industrial computer located in the facility, a mobile computing device, or a combination thereof, to obtain real-time or near real-time information on the status of the commissioning process by accessing the commissioning status of various components as they are updated by the various technicians. With the real-time or near real-time information on the commissioning process, the commissioning manager can better direct the technicians' efforts and determine where bottlenecks in the commissioning process might be occurring. Further, the improved commissioning system can reduce the time and expense involved in commissioning a plant or system within a plant.

According to one embodiment of the invention, a method for commissioning a production facility is disclosed. The production facility includes at least one control loop, wherein the control loop has a plurality of components and each component has a machine readable Identification (ID) tag containing a component specific identifier. The ID tag on a component to be commissioned is read with a technician unit to obtain the component specific identifier, and the component specific identifier is transmitted from the technician unit to a control unit. The control unit includes a component database storing data corresponding to each of the plurality of components in the production facility. Data corresponding to the component to be commissioned is received from the control unit as a function of the component specific identifier, and a loop folder is generated on the technician unit responsive to the data received from the control unit. The loop folder is displayed on a display of the technician unit, and commissioning data entered into the technician unit is stored. The commissioning data corresponds to commissioning of the component having the component specific identifier, and the commissioning data includes a current status of the component and a timestamp corresponding to entering of the commissioning data. The commissioning data is transmitted from the technician unit to the control unit, and the control unit is configured to store the commissioning data in the component database. A request for a report on a status of commissioning the production facility is transmitted from a commissioning manager unit to the control unit. The report is generated as a function of the commissioning data in the component database and is displayed on the commissioning manager unit.

According to another embodiment of the invention, a method for commissioning a production facility is disclosed. The production facility includes at least one control loop, wherein the control loop has a plurality of components and each component has a machine readable Identification (ID) tag containing a component specific identifier. A current location of a technician unit used for commissioning the plurality of components is obtained from a position locator in the technician unit. The current location is transmitted from the technician unit to a control unit, where the control unit includes a component database storing data corresponding to each of the plurality of components in the production facility. A list of components is received at the technician unit from the control unit, where the list of components includes each of the plurality of components that are within a predetermined distance of the current location of the technician unit. The ID tag on one of the plurality of components that are within the predetermined distance of the current location is read to obtain the component specific identifier, and the component specific identifier, which was read from the ID tag, is transmitted from the technician unit to the control unit. Data corresponding to the component to be commissioned is received from the control unit as a function of the component specific identifier, a loop folder is generated on the technician unit responsive to the data corresponding to the component received from the control unit, and the loop folder is displayed on a display of the technician unit. Commissioning data entered into the technician unit is stored, where the commissioning data corresponds to commissioning of the component having the component specific identifier and the commissioning data includes a current status of the component and a timestamp corresponding to entering of the commissioning data. The commissioning data is transmitted from the technician unit to the control unit, where the control unit is configured to store the commissioning data in the component database.

According to still another embodiment, a commissioning system for a production facility is disclosed. The production facility includes at least one control loop, where the control loop has a plurality of components and each component has a machine readable Identification (ID) tag containing a component specific identifier. The commissioning system includes at least one portable technician unit and a commissioning manager unit. The portable technician unit has an input device, a display, a communication interface, and a position locator. The input device is configured to obtain the component specific identifier from the ID tag on a component to be commissioned, and the position locator is configured to generate a signal corresponding to a current position of the technician unit. The communication interface is configured to transmit the component specific identifier and the signal corresponding to the current position of the technician unit to a control unit, where the control unit includes a component database storing data corresponding to each of the plurality of components in the production facility. The communication interface is configured to receive data from the control unit, where the data corresponds to the component to be commissioned, and the display is configured to display a loop folder with the data received from the control unit. The input device is further configured to receive commissioning data from a technician using the technician unit, and the communication interface is further configured to transmit the commissioning data to the control unit. The commissioning manager unit has an input device, a display, and a communication interface. The input device is configured to receive, a request for a report including at least a portion of the commissioning data, and the communication interface is configured to receive at least the portion of the commissioning data from the control unit. The display is configured to provide a visual indication of the report to a user of the commissioning manager unit.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Various exemplary embodiments of the subject matter disclosed herein are illustrated in the accompanying drawings in which like reference numerals represent like parts throughout, and in which:

FIG. 1 is a block diagram representation of the components of an electronic commissioning system according to one embodiment of the invention;

FIG. 2 is a block diagram representation of an exemplary facility utilizing an embodiment of the electronic commissioning system;

FIG. 3 is a block diagram representation of another exemplary facility utilizing an embodiment of the electronic commissioning system;

FIG. 4 is a flow diagram illustrating one embodiment of the electronic commissioning system;

FIG. 5 is a flow diagram illustrating further steps of receiving a component for the electronic commissioning system of FIG. 4;

FIG. 6 is a flow diagram illustrating further steps of installing a component for the electronic commissioning system of FIG. 4;

FIG. 7 is a flow diagram illustrating further steps of testing a component for the electronic commissioning system of FIG. 4;

FIG. 8 is a flow diagram illustrating further steps of a commissioning scheduler for the electronic commissioning system of FIG. 4;

FIG. 9 is an illustrative screen shot of a system portable device for recording the location of a component and for subsequently locating the component for commissioning;

FIG. 10 is an exemplary map showing locations of devices in a facility;

FIG. 11 is an example of a check sheet display generated by the commissioning system based on information from the component database for use by the technician when checking a specific component;

FIG. 12 is an example of an electronic pre-dynamic cheek sheet for a flow meter and valve;

FIG. 13 is an image of a menu presented to a technician on a portable device;

FIG. 14 is an exemplary component listing generated in response to an “Instrument List” command from the menu of FIG. 13;

FIG. 15 is an exemplary report charting the progress of a commissioning process for various areas of a facility;

FIG. 16 is an exemplary report plotting the degree of cumulative total percent completion of the commissioning project on a daily basis;

FIG. 17 is an exemplary report which plots and compares technician productivity; and

FIG. 18 is an exemplary report plotting the number of pre-dynamic checks made over a set period in a particular area over multiple days.

In describing the various embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION

The various features and advantageous details of the subject matter disclosed herein are explained more fully with reference to the non-limiting embodiments described in detail in the following description.

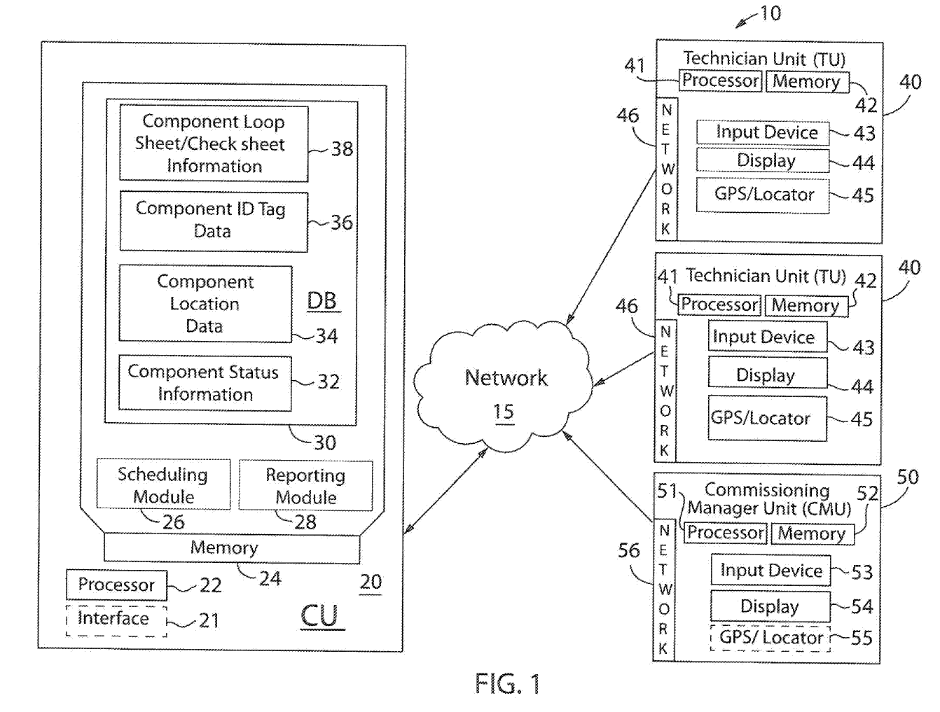

Turning initially to FIG. 1, a block diagram representation of the components of the electronic commissioning system 10 according to one embodiment of the invention is provided. The electronic commissioning system 10 includes a control unit (CU) 20, such as a general purpose computer or a server computer, and a plurality of portable devices (PD) (such as laptop computers, tablet computers, notebook computers, smartphones, or the like). The portable devices (PD) can be categorized as a technician unit (TU) 40 and as a commissioning manager unit (CMU) 50. According to one embodiment of the invention, each of the portable devices can be identical, and the determination of whether a portable device is a commissioning manager unit 50 or a technician unit 40 may be based on a permission level assigned in response to a log-in credential. Thus, for example, both the commissioning manager units 50 and the technician units 40 will be able to enter data related to the commissioning process. However, as described below, the commissioning manager unit 50 will also have permission to monitor the progress of the commissioning project and to control the commissioning project. Such permission would be denied a technician unit 40. According to another embodiment of the invention, different portable devices may be utilized for commissioning manager units 50 and technician units 40.

The control unit 20 can be located on site, or can be located remotely, for example, at an office of the firm conducting the commissioning. Alternatively, the control unit 20 can be an internet (or web) based server. Each control unit 20 includes a processor 22 and a memory 24. It is contemplated that the processor 22 may include a single processor or multiple processors operating in tandem or asynchronously. The memory 24 may include a single memory device or multiple memory devices. At least a portion of the memory 24 is non-transitory memory and is configured to store instructions and data when power is removed from the control unit 20. The memory 24 may include, for example, a hard drive, a solid-state storage device, read only memory (ROM), random access memory (RAM), a removable storage medium, such as a floppy drive, a flash memory drive, a memory card slot, or various combinations thereof. Optionally, an interface 21 may be provided on the control unit 20 to provide a visual display of data stored in the control unit or to accept input from a user of the control unit. Alternately, the control unit 20 may have no direct interface 21 but rather may be accessible via a network 15 such as the Internet or via an intranet.

Each portable device 40, 50 also includes a processor 41, 51 and memory 42, 52. It is contemplated that the processor 41, 51 may include a single processor or multiple processors operating in tandem or asynchronously. The memory 42, 52 may include a single memory device or multiple memory devices. At least a portion of the memory 42, 52 is non-transitory memory and is configured to store instructions and data when power is removed from the portable device 40, 50. The memory 42, 52 may include, for example, a hard drive, a solid-state storage device, read only memory (ROM), random access memory (RAM), a removable storage medium, such as a floppy drive, a flash memory drive, a memory card slot, or various combinations thereof. Each portable device 40, 50 further includes a network communication interface 46, 56. Preferably, the network communication interface 46, 56 include wireless communication capabilities, so that the portable devices 40, 50 communicate with (i.e., receive information from and send information to) the control unit 20 wirelessly via the network 15. Preferably, a least a portion of the network 15 is a wireless network, but any communication system that will enable portable devices 40, 50 to communicate with the control unit 20 wirelessly can be used. If the control unit 20 is located at the commissioning site, the commissioning manager unit 50 can be incorporated in the control unit. If the control unit 20 is remote from the commissioning site, access to the control unit 20 by both the commissioning manager unit 50 and each technician unit 40 may be accomplished via a log-in procedure. In the latter instance (i.e., when the control unit is remote), whether or not a particular portable device 40, 50 is a commissioning manager unit 50 or technician unit 40 can be controlled by permissions granted (i.e. login credentials) upon logging in to the commissioning system 10 at a particular portable device 40, 50.

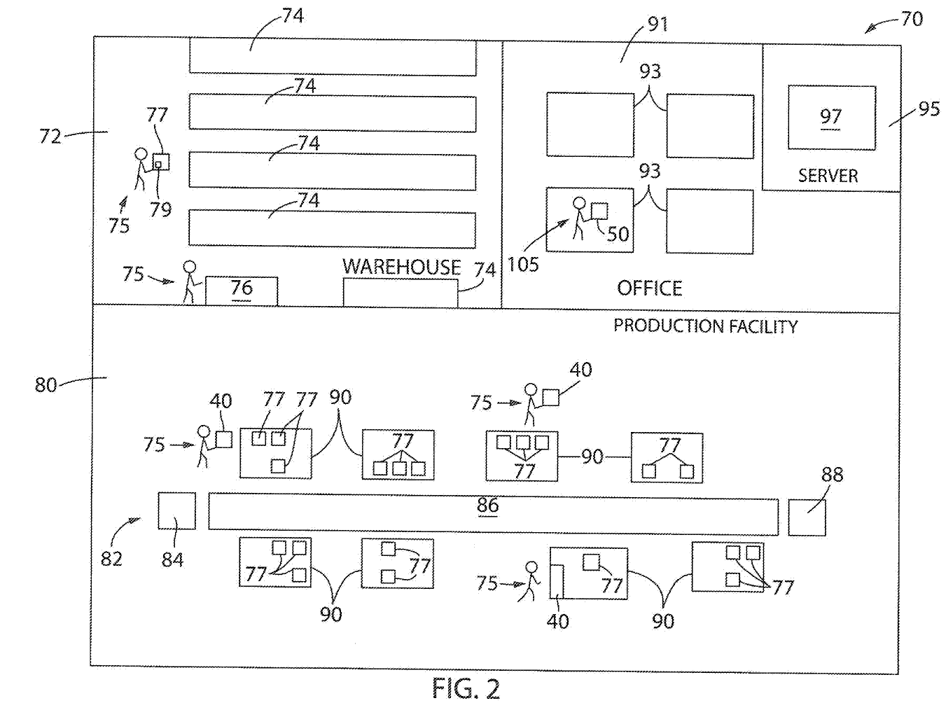

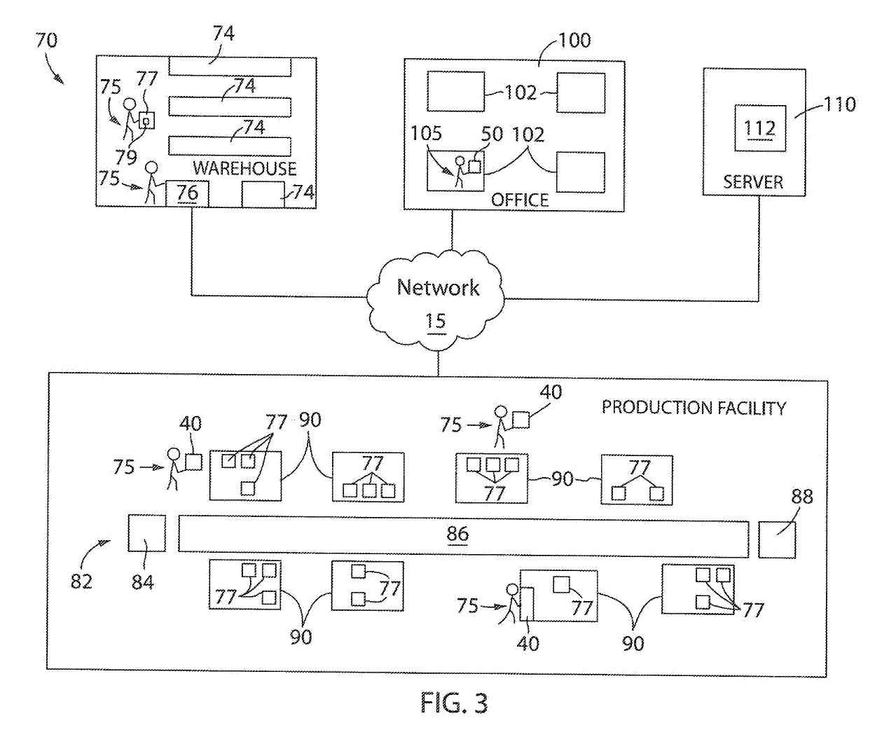

Each portable device 40, 50 further includes at least one input device 43, 53 to receive information from a user. The input device 43, 53 may be, but is not limited to, a keyboard, a mouse, a track ball, a touch pad, a touch screen, or the like. The input device 43, 53 may further include a sensor, such as an infrared scanner, optical scanner, radio frequency (RF) scanner, or the like. The input device 43, 53 may be configured to interact with an identification tag located on a component to retrieve a unique identifier from the ID tag. The portable device 40, 50 may also include a position locator 45, 55 providing coordinate information for the device. The position locator 45, 55 may be, for example, an interface to a satellite positioning system, such as the global positioning system (GPS), to retrieve a current location. The portable device 40, 50 uses the position information such that at least a coordinate (latitudinal and longitudinal) position of the device within the facility 70 (see also FIGS. 2 and 3) can be determined. Optionally, the position locator 45, 55 may be configured to provide elevation information for the portable device 40, 50 as well. Each portable device 40, 50 also includes a display 44, 54 on which data may be provided to a technician or commissioning manager.

The control unit 20 is configured to execute a number of modules. The invention will be described herein with respect to an exemplary set of modules. The exemplary set of modules is not intended to be limiting. It is contemplated that the number and functions of modules may vary without deviating from the scope of the invention. The control unit 20 may execute a first module which maintains a database (DB) 30 and receives, stores, updates, and maintains all the information related to the components 77 of the system being commissioned. This information includes, at least the information noted just above. The information can be maintained in a relational database DB which will hold data regarding the status of component commissioning 32, component location data 34, component identification (ID) data 36, and component checksheet (or testing) data 38.

The control unit 20 is further configured to execute a reporting module 28 which may access the database 30 and based, for example, on the component status information 32 will inform the commissioning manager in real (or near-real) time of the status of the commissioning project and provide real (or near-real) time information where slowdowns in the commissioning project may be occurring. As will be discussed below, the component status information 32 is typically intended to be updated in real (or near-real) time as commissioning progresses. As used herein, it is contemplated that real time updates may occur, for example, via an automatic data packet generated by a technician unit 40 as a task is performed. Optionally, a component may have a network interface and may provide a status update to the control unit 20 as a task is performed. A near-real time update may occur, for example, by a technician entering data in the technician unit 40 upon completion of a commissioning step. Optionally, the control unit 20 may be configured to periodically poll technician units 40 to obtain status of completed tasks or tasks in progress at intervals of, for example, 5-30 minutes. The reporting module 28 can then update and generate reports regarding the status of the commissioning process.

Based on this information, the commissioning manager can direct the energies of the technicians to specific areas in the facility 70, by, in part, controlling which of the components are currently available for commissioning.

Turning next to FIGS. 2 and 3, exemplary block diagram representations of facilities 70 at which the commissioning system 10 disclosed herein is implemented. The facility 70 may include a warehouse 72 at which components 77 are received. A technician 75 applies an ID tag 79 to each of the components 77 to be commissioned as they arrive at the warehouse 72. The components 77 may then be stored on racks 74, pallets, bins or in any conventional means within the warehouse 72 until required for installation in the process line 82 or equipment to be commissioned. Optionally, the components 77 may be stored upon arrival and the technician 75 may affix the ID tag 79 during installation in the process line 82 or equipment to be commissioned. According to still another embodiment, warehouse personnel may install the ID tag 79 on the component for later use by a technician 75. Optionally, the components 77 may be stored elsewhere, for example, in a temporary facility during assembly and commissioning of the process line 82 or equipment.

The facility 70 includes a component check station 76 at which the component may be inspected and calibrated, if necessary. In some embodiments, a technician 75 performs the inspection and calibration and may apply an ID tag 79 on the component 77 after the inspection and calibration is complete. According to the illustrated embodiment, the component check station 76 is located in the warehouse 72. Optionally, the component check station 76 may be located in a temporary facility, such as a construction trailer or the like that is present at the facility during the commissioning process.

After inspection and calibration, the components 77 may be installed in the system to be commissioned. According to the illustrated embodiment, a production facility 80 includes a process line 82, which, in turn, includes an insertion station 84, a transfer line 86, and a removal station 88. Multiple stations 90 are positioned along the transfer line 86. It is contemplated that a work piece may be loaded into the process line 82 at the insertion station 84 and moved between stations 90 by the transfer line 86. Movement may be continual or intermittent with the different stations 90 performing an action on the work piece as it moves past or is positioned by each station 90. The work piece is removed from the process line 82 at the removal station 88. The illustrated process line 82 is intended to be exemplary only, is not limiting, and is included for discussion herein. The system to be commissioned may include other equipment and other configurations such as stand-alone machines, transfer lines, dip tanks, machining centers, reactors, boilers, wash stations, and various other manufacturing and processing equipment. Each station 90 may include one or more control loop, where each control loop includes one or more components 77 arranged in various configurations according to the task performed at the station 90. Technicians 75 may move between stations 90 to perform the installation and commission steps. Technicians 75 may carry portable technician units 40 with them. Optionally, a station 90 may include a technician unit 40 incorporated into the station.

The facility may also include an office space 91 and a server room 95. The office space 91 may include multiple offices 93, where one office 93 belongs to a commissioning manager 105. The commissioning manager 105 has a commissioning manager unit 50, which may be a desktop computer or laptop computer in the office 93. Optionally, the commissioning manager unit 50 may be a tablet computer, a notebook computer, a smartphone, or other mobile computing device. Optionally, the commissioning manager 105 may be one of the technicians 75 who has a supervisory role or may be from an outside company and may utilize, for example, the temporary facility, such as a construction trailer, discussed above as an office 93. The server room 95 includes a server 97, which may be configured as the control unit 20 discussed above. It is further contemplated that the warehouse 72, production facility 80, office space 91, and server room 95 may be located in a single building, as illustrated in FIG. 2, or in multiple buildings, as illustrated in FIG. 3. The multiple buildings may be connected with a network, which may include the Internet or an Intranet accessible only at the facility 70. The illustrated facilities 70 are not intended to be limiting and it is understood that a system to be commissioned may be located in a single building or multiple buildings and that the various elements may be arranged in different configurations without deviating from the scope of the invention.

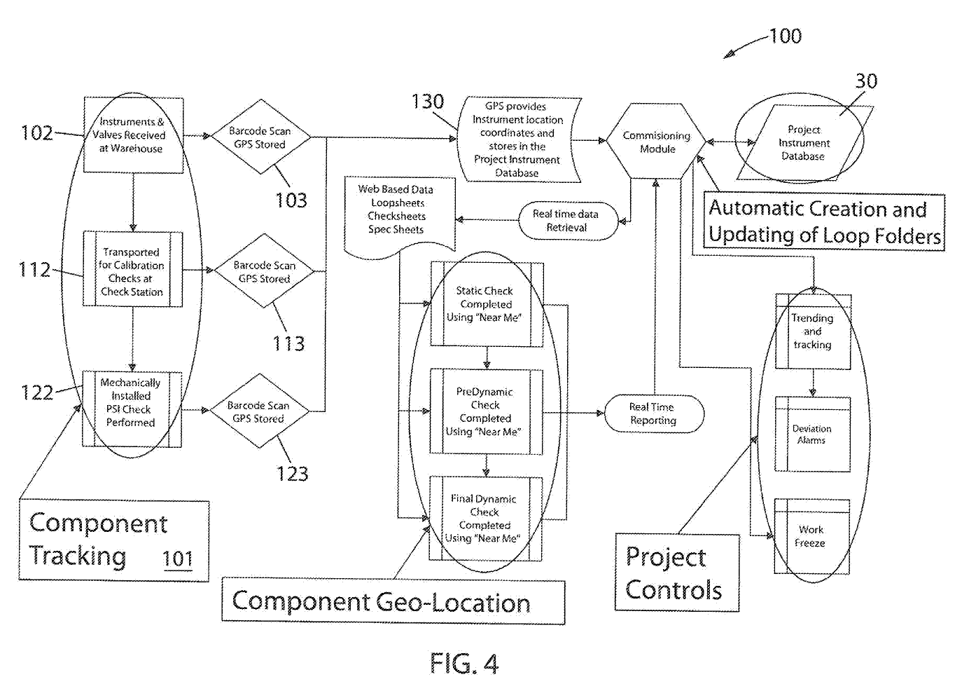

Turning next to FIG. 4, the commissioning process 100 for a facility 70 is shown in flow chart form. The commissioning process 100 starts with the receipt of the valves, instruments, and other devices in the system, collectively referred to as components 77, at the warehouse 72, as shown in step 102. The component 77 is then transported to the component cheek station 76 (which can be a location within the warehouse, a trailer at the site, etc.) where the component is calibrated, as shown in step 112. After the component 77 has been checked and calibrated, if necessary, the component 77 is mechanically installed in the facility 80 and a Pre-Static Inspection (PSI) is performed on the component 77, as shown in step 122. At one of the steps described above, the component 77 may be provided with the machine-readable ID tag 79 containing a component specific identifier. The ID tag 79 can be a label with a barcode label, an RFID tag, or any other type of tag or label which can be machine read. At each of these steps (102, 112, or 122), the component barcode can be scanned or otherwise read (as shown in steps 103, 113, and 123) and the GPS location of the component is stored and updated in a device location field in the database 30. Thus, the commissioning manager can perform component tracking 101 and determine, at all times, the location of each component 77.

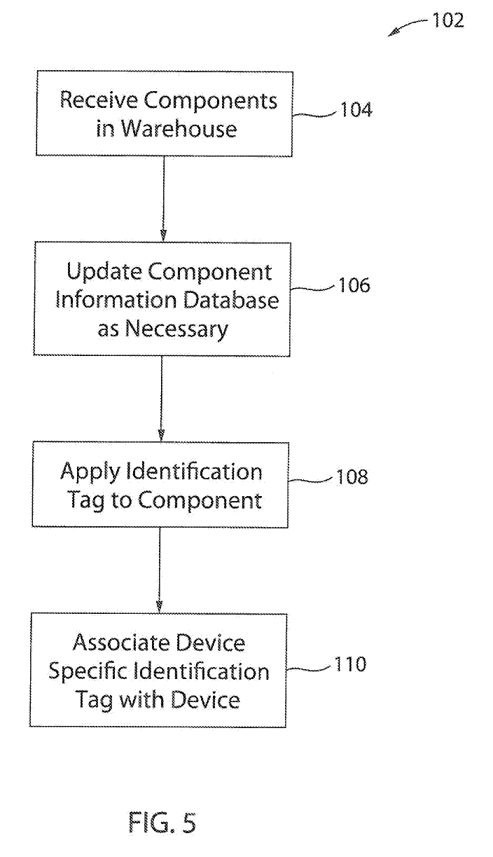

Referring also to FIG. 5, additional details of step 102, receiving a component 77, are illustrated. The component 77 is received in the warehouse 72 at step 104. The technician 75 or warehouse personnel may update the component status information 32 in the database 30 indicating the component 77 has been received, as shown in step 106. The ID tag 79 is applied to the component, as shown in step 108, and the component ID tag data 36 may be updated to associate the component 77 with the ID tag 79 associated with the device, as shown in step 110. As previously indicated, the ID tag 79 may be read by the technician unit 40, for example, by scanning a barcode (step 103), such that the current location of the component 77 is determined and stored in the database 30.

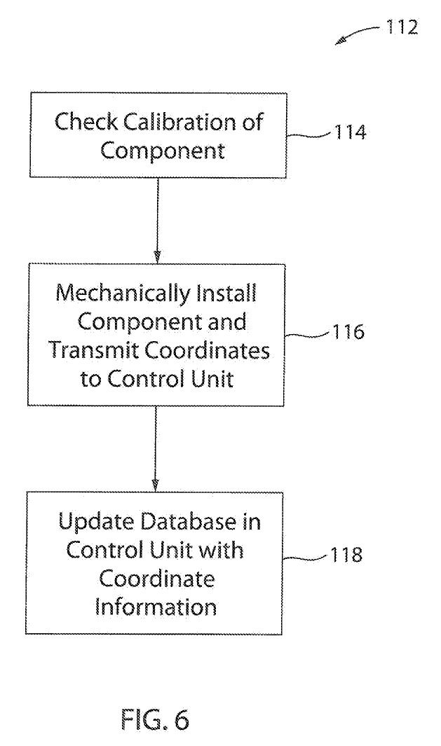

With reference then to FIG. 6, additional details of step 112, calibrating a component 77, as well as installing the component are illustrated. Prior to installation, components 77 may be brought to the check station 76. At the cheek station 76, the component 77 may undergo a visual inspection to verify, for example, the component is the correct component with the correct features according to the specification for the system being commissioned. Certain components 77 may require calibration including, for example, adjusting or setting parameters on electrical components, adjusting or setting selection switches, such as dual in-line package (DIP) switches, dials, and the like to select operation, adjusting pressure or relief valve settings, or measuring output signals corresponding to settings. At step 114, the calibration of the component is checked, as required. At step 116, the component is mechanically installed in the system. After installation, the current location of the component 77 may be determined by scanning the ID tag 79 on the component 77 with the technician unit 40 or via any other tracking system utilized. At step 118, the component location data 34 in the database 30 is updated based on the scan of the ID tag 79.

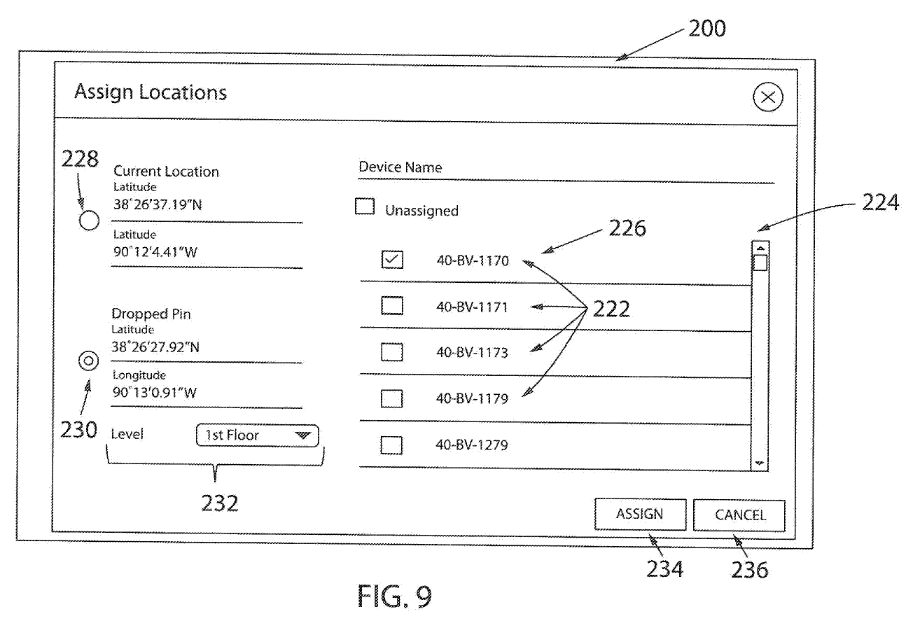

FIG. 9 shows an exemplary location interface screen 200 on a portable device 40, 50 which is used to record the location of a component 77. The technician unit 40 includes a scanner as an input device 43. The technician 75 initially scans the barcode of the ID tag 79 on the component 77 to identify the component 77. The technician unit 40 communicates with the control unit 20 via the network 15 to obtain component information corresponding to the component 77 identified by the scanned barcode. Optionally, the technician unit 40 may have a copy of the component ID tag data 36 stored in the memory 42 of the technician unit 40. It is contemplated that the technician unit 40 may be updated manually, for example, at the start of a shift or automatically, via scheduled updates to obtain new devices added to the database 30 in the control unit 20. A list of component names 222 is presented, for example, in an “Instrument Tag” scroll box 224 on the location interface screen 200. The device identified by the scanner may be checked and become an active component 226 in the “Instrument Tag” scroll box 224. One exemplary format for the component names 222 is illustrated in FIG. 9. The first, numeric, portion of the component name 222 (for example, “40”) identifies a control loop of which the component is a part. The second, alphabetic, portion of the component name 222 (for example, the “BV”) identifies the type of component (e.g., ball valve, pressure sensor, temperature sensor, etc.). The third, numeric, portion identifies the component number within the control loop previously identified.

Having identified a component 77, a location is then assigned. The location interface screen 200 includes a Current Location and a Dropped Pin selection. According to the illustrated embodiment a first radio button 228 selects the Current Location and a second radio button 230 selects the Dropped Pin. Optionally, various other user selection interfaces, such as text boxes, drop down menus, check boxes and the like may be utilized to select the source of a location.

Selecting the first radio button 228 for “Current Location” assigns position coordinates (latitude and longitude) for the component 77 as determined from the satellite position locator 45 (e.g., GPS) of the technician unit 40. In some embodiments, the portable device 40, 50 may include an altimeter. In other embodiments, the portable device 40, 50 may be configured to receive elevation information from the satellite position information communicated to the unit. This altitude information can automatically be converted to “level” information (e.g., ground level, level 2, level 3, etc.) for the specific facility. As an alternative, a user interface 232, such as a drop-down menu, may be provided to the technician 75 for entry of the level information for the component 77. If the elevation information is automatically communicated, it may, in turn, be displayed on the drop-down menu 232 by selecting the option corresponding to the received information. The location interface screen 200 illustratively is shown to have a level location selector 232.

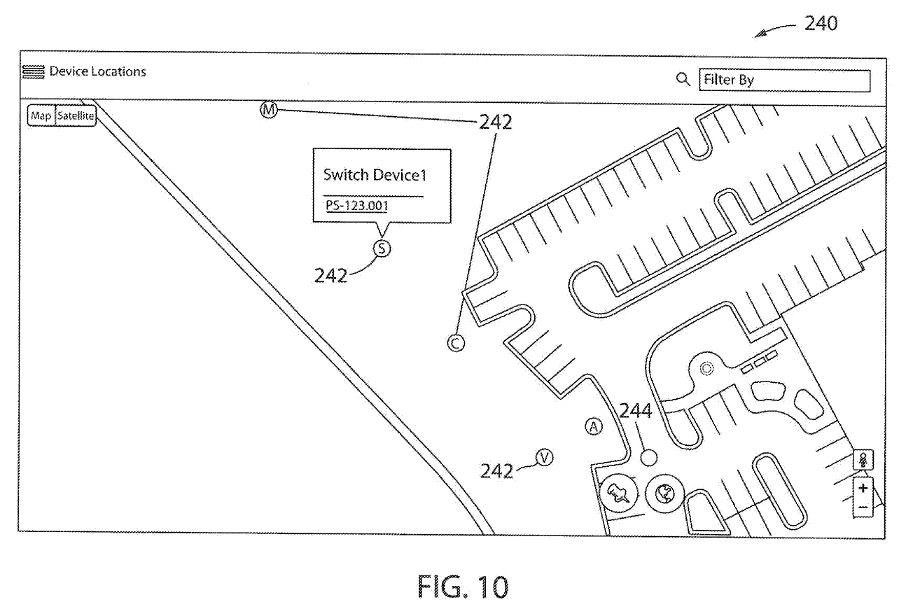

Selecting the second radio button 223 for “Dropped Pin” assigns position coordinates based on a manual process. With reference, for example, to FIG. 10, locations of components 77 or buildings within a facility 70 may be shown on a map or on a schematic representation of the facility 70. Coordinates for the buildings or for at least a portion of the locations on the map may be determined and stored in the technician unit 40. A “pin”, or any other marker, may be placed on be map or schematic to identify the location of a component. The stored location is shown on the location interface screen 200. Optionally, the “Dropped Pin” interface may include a drop down menu with multiple stored locations. The technician may first select one of the stored locations and then select the radio button 223 to associate the stored location with the selected component 77.

The location interface screen 200 further includes an assign button 234 and a cancel button 236. Once a component 77 is identified and the location coordinates and level are set, the technician 75 may press the assign button 234 at the bottom of the screen 200. When the “Assign” button 234 is pressed, the portable device 40, 50 will transmit the coordinates and level information for the selected component 77 to the control unit 20, and the control unit 20 will then update the component location data 34 in the database 30. Position information for each component 77 in the facility 70 may be provided to the database 30 in this fashion during mechanical installation of each component.

With reference again to FIG. 4, the position location data for each component 77 can be overlaid on an electronic map, as shown in step 130. If the ID tag 79 is installed on the components 77 as they are received, the component location data 34 may identify a number of components 77 in the warehouse 72 or in another storage location awaiting installation. For those components 77 that have been installed as described above, the position information will show the location of each component 77 on a map. As previously discussed with respect to FIGS. 2 and 3, the facility 70 may include a single building or multiple buildings spread out over a site. It is further contemplated that a portion of the components may be installed outside, for example, on a pipeline transferring a fluid or a gas between two locations. The map provides a quick reference for a technician 75 to identify the location of a component 77 and, in particular, to find the location of an installed component 77.

With reference also to FIG. 10, an exemplary map 240 of a facility 70 is illustrated. As will be discussed more fully below, the technician 75 can execute an application on the portable device 40, 50 that utilizes satellite image data on which position information may be overlaid. The application on the portable device 40, 50 may utilize, for example, a commercially available mapping application, such as Google® Earth, MapQuest®, or the like. Alternatively, the mapping application can utilize a schematic layout, or other rendering of the production facility. The mapping application overlays the locations of each component 77 on the map or schematic layout.

FIG. 10 shows the location of a number of components 77, identified by component identifiers 242 (i.e., reference letters C, V, M, S, and A) superimposed over a satellite (overhead) view of a facility 70. The illustrative map shown in FIG. 10 is a “high altitude” view of the facility 70. The mapping application on the portable device 40, 50 preferably has the capability to zoom in and out on an area. When zoomed out, a single component 77 may be identified at a location or multiple components may be overlaid such that the topmost component is visible. As the application zooms in on an area, additional components 77 in an area can be more easily differentiated from each other. When zoomed in close, component identifiers 242 for each component will be visible. Additionally, a user location marker 244 may be displayed on the map, which denotes the location of a technician 75 who has requested the displayed map 240.

In cooperation with the receipt of components 77 to the warehouse, the component database 30 may be prepared and updated to include all the necessary information for each component 77. Updating the component ID tag data 36, the component location data 34, and at least an initial status for the component status data 32 are discussed above. The component database 30 further includes component loop and check sheet information 38. The component loop and cheek sheet information 38 may include, for example, the following items for each component 77: instrument manufacturer's specification/data sheet, component manufacturer, component serial number, component model number, piping and instrumentation diagram, loop diagram, loop check test sheet/checklist, instrument calibration information, plot plan/location diagram, looping test procedure, hook-up diagram/instructions, control/function narrative, alarm set point list, construction completion information, device interlock diagram, device flow sizing sheet, the device Certificate of Conformance (CoC), the device Certificate of Origin (COE), the device Material Test Report (MRT), the device NACE certificate, and the device instrument configuration. It will be appreciated that the information for the specific component will vary depending on the type of component (e.g., control valve, sensor, pump, etc.) and that the foregoing list is illustrative only.

In operation, the electronic commissioning system 10 is operative to generate and display electronic loop checklists for each component 77. When a technician 75 intends to perform a commissioning step on one of the components 77, a commissioning module executing on a portable device 40, 50 creates a loop folder 250. The loop folder 250 includes loop sheet information that is generated from the component information (32, 34, 36, 38) contained in the component database 30 and displayed on the portable device 40, 50. The loop folders 250 generated from the component information contained in the database, reduces or eliminates the need for physical folders historically used during commissioning of a facility. The electronic commissioning system 10, therefore, reduces commissioning time required for updating and maintaining physical folders.

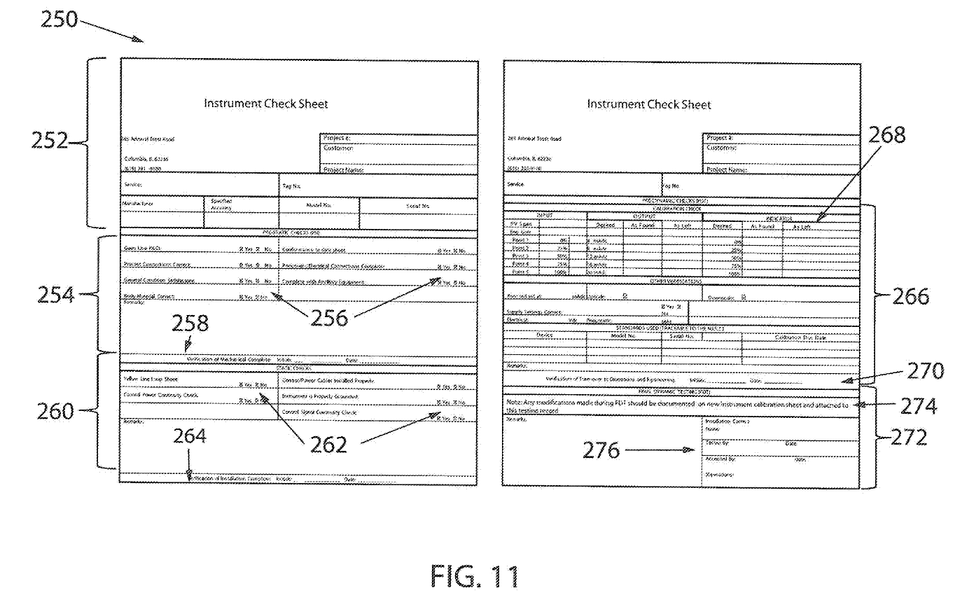

A sample loop folder 250 is illustrated in FIG. 11. As noted above, the loop folder 250 is generated based on the information in the database 30 for the particular component 77 and is generated when a technician 75 initiates a commissioning step for the component. The loop folder 250 includes a first section 252 which includes information for the selected component 77. The first section 252 may include, for example, project information such as a project number, a customer name, and a project mane.

Additionally, the first section 252 identities the specific component 77, the number on the component tag 79, and other component information such as the component's specified accuracy, and the component's manufacturer, model number and serial number.

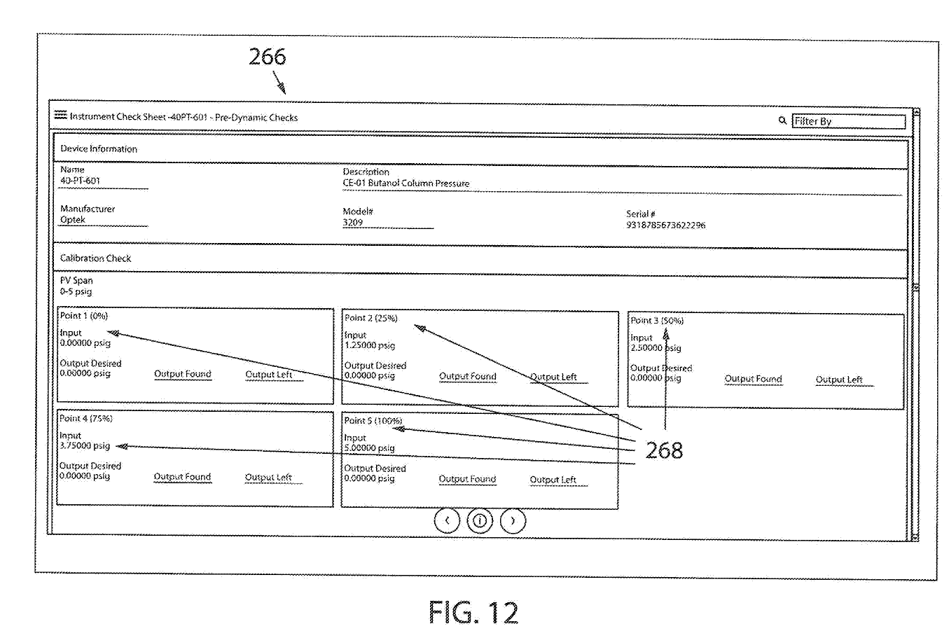

The loop folder 250 also includes flour subsections for each component 77, where each sub-section preferably corresponds to a commissioning step. As illustrated, the sub-sections include: a pre-static check subsection 254, a static check subsection 260, a pre dynamic check subsection 266, and a final dynamic check subsection 272. Each of the check subsections includes electronic forms 256, 262, 268, and 274 which enable the technician to indicate that each of the necessary checks for each commissioning step for the specific component 77 has been completed. For example, the form 256 for the pre-static check subsection 254 includes check boxes to indicate that the mechanical connections for the component are correct; and the form 262 for the static check section 260 includes check boxes to indicate that the electrical connections for the component 77 are correct. As seen, there are “yes” and “no” check boxes in each form 256, 262, to enable the technician 75 to specifically note whether or not the various mechanical and electrical connections required for the specific component 77 have been properly made. Optionally, any other suitable interface, such as radio buttons, drop-down boxes, and the like may be utilized. The pre-dynamic check subsection 266 (shown enlarged in FIG. 12) includes data entry boxes 268 wherein the technician 75 can enter the relevant data for the specific component 77. For the exemplary pre-dynamic check subsection shown in FIG. 12, the component 77 is a pressure transducer (PT), and thus includes data input boxes 268 for items such as 0% reading output found and left, 25% reading output found and left, 50% reading output found and left, 75% reading output found and left, 100% reading output found and left. It will be appreciated that the specific data input boxes for the components will vary by the type of the component 77. From the component information 38 in the database DB, the commissioning system 10 knows what type of component (i.e., pressure valve, flow control meter, etc.) is being checked, and automatically provides the correct data input boxes for the specific component.

Turning back to FIG. 11, at the bottom of each check subsection, the cheek subsection includes an electronic signature portion 258, 264, 270 and 276 where the technician 75 performing the specific checks can electronically sign off on the specific commissioning step that was performed. As will be discussed below, when the technician 75 performs the checks/tests for each sub-section of the loop folder 250 and then electronically signs off on the check subsection, the commissioning module executing on the technician unit 40 communicates with the control unit 20 to update the database 30 with relevant information, such as completion of a particular check sheet, the name of the technician who performed the checks, and the date and time the cheek sheet was completed.

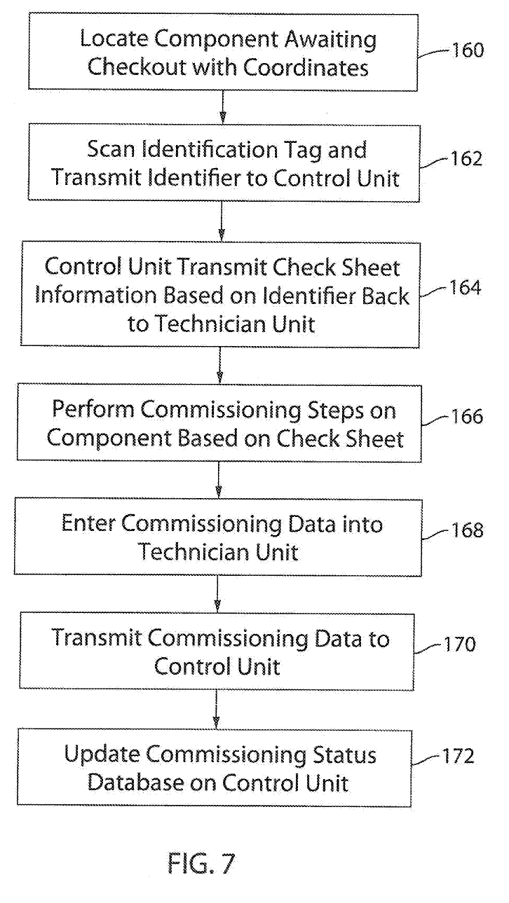

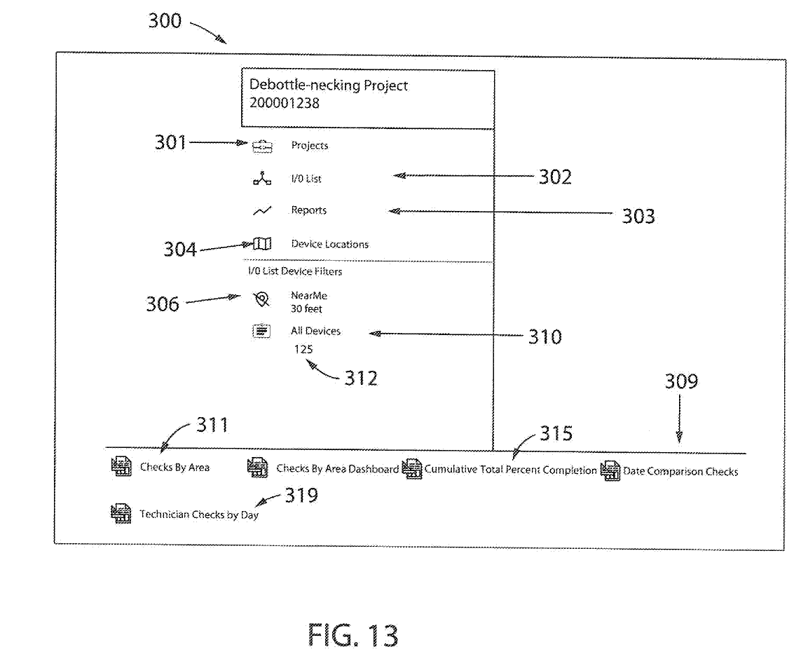

Turning next to FIG. 7, the steps in the commissioning process are illustrated. The commissioning process for each component starts with the technician 75 locating the component, as shown in step 160. The technician 75 may launch the commissioning module executing on the technician unit 40 to begin locating a component 77. A menu 300, such as the exemplary menu shown in FIG. 13, is displayed on the technician unit 40. The illustrated menu 300 includes soft buttons or keys 301-304, which may be activated by a touchscreen interface on the technician unit 40. The soft buttons 301-304 bring up modules for “Projects” (301), an “I/O List” (302), “Reports” (303), and “Device Locations” (304). Pressing the “Projects” button 301 allows a technician 75 to switch between commissioning projects stored on the technician unit 40. Pressing the “I/O List” button 302 presents the technician with a list of the components 77 in the facility 70 with inputs or outputs. Selecting the “Reports” button 303 provides the technician 75 with certain reports, discussed more fully below, which show the status of the commissioning process in near real-time. The reports the technician 75 can see may be limited by log-in permissions, as noted above. Selecting the “Device Locations” button 304 provides the technician 75 with a list of all the locations for all components 77 as stored in the component status data 32 in the database 30.

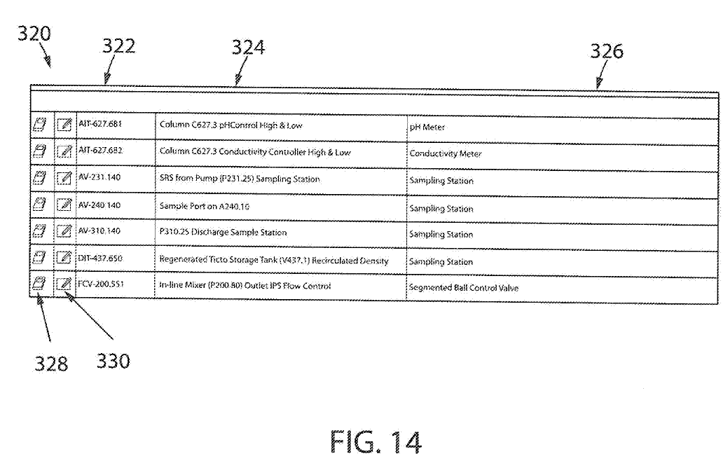

Additional soft buttons may be provided to provide a list of I/O devices based on selected filters. According to the illustrated embodiment, two filters are shown. A first filter provides a “Near Me” (306) soft button and a second filter provides an “All Devices” (310) soft button. Other filters may include, but are not limited to, devices remaining to be commissioned, devices at each stage of commissioning, devices within a control loop, or devices that are unavailable. Selecting the “All Devices” button 310 will present the technician 75 with a list of all components 77 in the system being commissioned and their current status. Below the soft button, a notation 312 is provided where the notation identifies the number of components 77 in the system. In the illustrative example, there are 125 instruments in the system. Because the commissioning system 10 updates the status of the project in real-time, the list of components 77 included under the “All Devices” soft button 310 and the notation 312 indicating the number components 77 will change in near real-time if new components are checked in. Selecting the “Near Me” button 306 provides the technician 75 with a list 320 of components 77, such as the list shown in FIG. 14, which lists the components 77 in tabular format that are within a predetermined distance or radius from the technician.

Turning next to FIG. 14, the illustrated instrument list includes the identifier 322 on the instrument tag 79, a description of the service in which the instrument is used 324, and the type 326 of device (valve, sensor, meter, etc.) to which the instrument belongs. On the left side of the instrument table, the table includes a left most column with a first icon 328, and a second column with a second icon 330. Selecting the first icon 328, loads the electronic loop folder 250 for the selected instrument. Selecting the second icon 330 allows the technician 75 to navigate to the next electronic checksheet in the sequence for the selected instrument. In another embodiment, the list of components 77 may be presented to the technician 75 on a map, such as the map illustratively shown in FIG. 10, so that the technician 75 can visually see where the components 77 are relative to the technician's location 244 on the map. As can be appreciated, the commissioning system 10 utilizes the component location data 34 that was previously stored in the database and the current position of the portable device 40, 50 to determine which components are within the predetermined distance of the portable device 40, 50. Using the map application, which shows the location of the components 77 overlaid on an image of the facility 70 and in comparison to the technician's current position 244, the technician 75 can quickly find the component 77 to test, substantially reducing the time required for the technician to locate the component.

Referring again to FIG. 7, when the technician 75 arrives at the component 77, the technician will scan the component's bar code on the identification tag 79 using the portable device's 40, 50 scanner, as shown in step 162. As can be appreciated, the components 77 will need to be installed in a manner such that their bar codes on the identification tag 79 can be easily read by the scanner of the portable device 40, 50. Upon scanning the identifier on the component, the technician unit 40 will communicate with the control unit 20 via the network 15 to indicate which component 77 has been scanned. The control unit 20 will, in turn, transmit the data 32-38 stored in the database 30 for a loop folder of the scanned component to the technician unit 40, as shown in step 164. The loop folder 250 will be displayed on the technician unit 40, and the technician 75 can proceed with the necessary checks to commission the scanned component. As can be appreciated, the technician unit 40 loads the loop folder 250 based on the scanned bar code from the identification tag 79, and the bar code from the identification tag 79 was previously stored in the component ID tag data 36 for the particular component 77. As a result, the possibility of the technician 75 inadvertently recording the test results for a component 77 on the incorrect electronic test sheet when commissioning a component is substantially reduced. That is, by loading the loop folder 250 based on the component's bar code information, the chance for human error in selecting the loop folder 250 is substantially reduced.

Once the electronic checksheet for the component has been loaded into the technician unit 40, the technician 75 will perform the necessary checks according to the current status of the component 77, as shown in step 166. According the exemplary loop folder, four levels of testing will be performed (i.e., pre-static check, static check, pre-dynamic check, dynamic check). At step 168, the technician will electronically sign off on the commissioning checksheet once the tests have been completed. As shown in step 170, the technician unit 40 will then transmit the test information to the control unit 20, and, as shown in step 172, the control unit 20 will update the commissioning status data 32, component location data 34, and the component check sheet information 38 in the database 30 as required. The technician unit 40 may also provide the name of the technician 75 performing the testing and the date and time the testing for the component 77 was completed. In this manner, the status of the commissioning of each component 77 in the facility 70 can be determined on a real time, or near-real time, basis. As will be discussed in more detail below, this allows for a level of monitoring of the commissioning process and a level of control of the commissioning process that has heretofore not been possible.

A commissioning manager 105 may use the real time, or near-real time, information provided by the technicians to monitor the commissioning process. The commissioning manager 105 logs on to one of the portable devices 40, 50. As previously discussed, the technician unit 40 and the commissioning manager unit 50 may be identical devices where the login credentials identify whether a technician 75 or a commissioning manager 105 is accessing the device and authorized access is provided to information and modules accordingly. It is contemplated that the commissioning manager 105 will have access to the features on the portable devices 40, 50 described above with respect to the technician 75 as well as additional features described below.

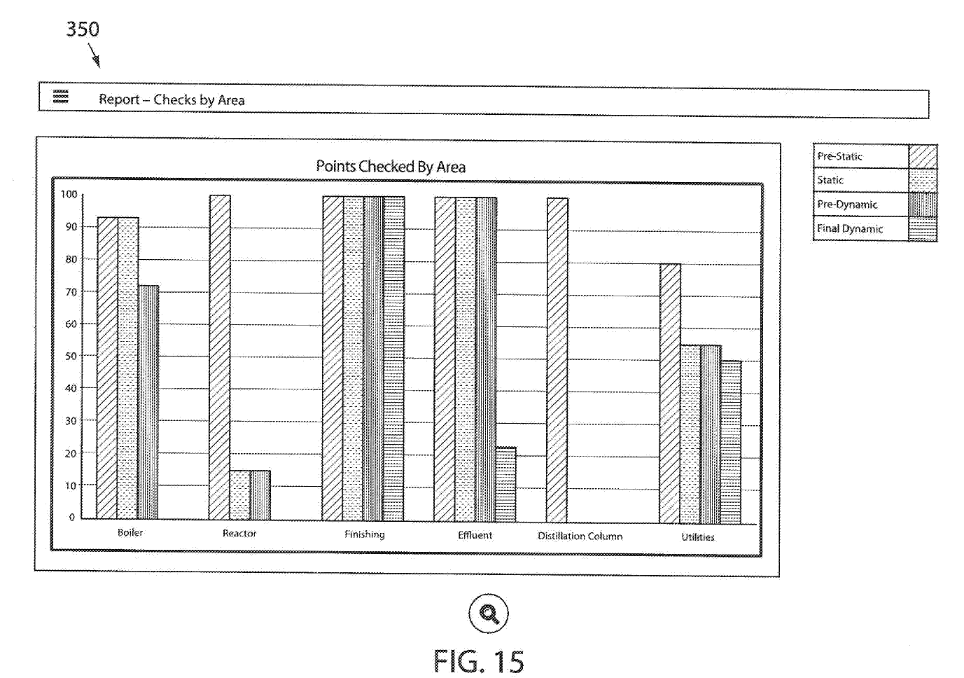

In order to obtain the current status of the commissioning process, the commissioning manager 105 can press the reports button 303 on the portable device 40, 50. According to the illustrated embodiment, the reports button 303 will load a reports menu 309, shown across the bottom of the exemplary menu screen 300 in FIG. 13. The reports menu 309 allows the commissioning manager 105 to select reports which illustratively show progress of the commissioning project in various ways. In accordance with, a first reporting format, the component status may be provided according to area, by selecting the “Checks by Area” option 311. The commissioning manager unit 50 may then generate a “Points Checked by Area” graph 350 as illustratively shown in FIG. 15, which shows the status of the commissioning process for selected areas of a facility 70. The status is based on the real-time, or near-real time, commissioning data that is transmitted to the control unit 20 by each of the technician units 40 active in the facility 70.

According to the exemplary graph, the status for a boiler, reactor, finishing area, effluent area, distillation column and utilities is plotted. The graph includes bars which show, on a percentage basis, the degree of completion of each of the four check steps, (i.e., pre-static check, static check, pre-dynamic check, and final dynamic check) in each area. For the boiler, the pre-static and static cheeks are about 92% complete, the pre-dynamic check is about 72% complete, and the final dynamic testing has not yet started. For the reactor, the pre-static check has been completed, the static and pre-dynamic tests are each about 15% complete, and the final dynamic testing has not yet started. For the finishing area, all of the commissioning steps are complete. For the effluent area, the pre-static, static, and pre-dynamic testing have all been completed and final dynamic testing is about 22% complete. For the distillation column, the pre-static check has been completed, but no additional checks have yet been started. For the utilities, pre-static checks are about 80% complete, static and pre-dynamic checks are about 55% complete, and the final dynamic checks are about 50% complete.

Upon inspection of the area graph 350 of FIG. 15, the commissioning manager 105 may determine that there is a bottleneck in the commissioning process at the reactor and at the distillation column. For example, because the pre-static and static checks for the boiler are at the same level, the commissioning manager 105 can determine that the mechanical connections for the boiler components may not be complete. Similarly, for the reactor, the commissioning manager 105 may determine that because the static and pre-dynamic checks are at the same level, the electrical connections for the components 77 at the reactor may not be complete. For the utilities, because the pre-static checks have not been completed, and because the static and pre-dynamic checks are at the same level, the commissioning manager 105 can determine that mechanical connections for a portion of the components 77 still need to be made and that for those components 77 that have been mechanically connected, at least a portion still need to be electrically connected. Because no static checking has been started at the distillation column, the commissioning manager 105 may determine that the electrical connections for the components 77 at the distillation column are not complete.

Based on the graph of FIG. 15, the commissioning manager 105 can have technicians 75 confirm the observations made above. Specifically, the commissioning manager 105 can assign technicians 75 to confirm the status of the mechanical connections at the boiler, the electrical connections at the reactor and the distillation column, and the mechanical and electrical connections at the utilities area. Further, if required mechanical and/or electrical connections have not been made, the commissioning manager 105 can determine why such connections have not been made and take necessary action to ensure that the required mechanical and/or electrical connections are made. This report on the status of the commissioning process thus gives the commissioning manager 105 an early warning that corrective action may be necessary in order to complete the commissioning procedure by a designated completion date.

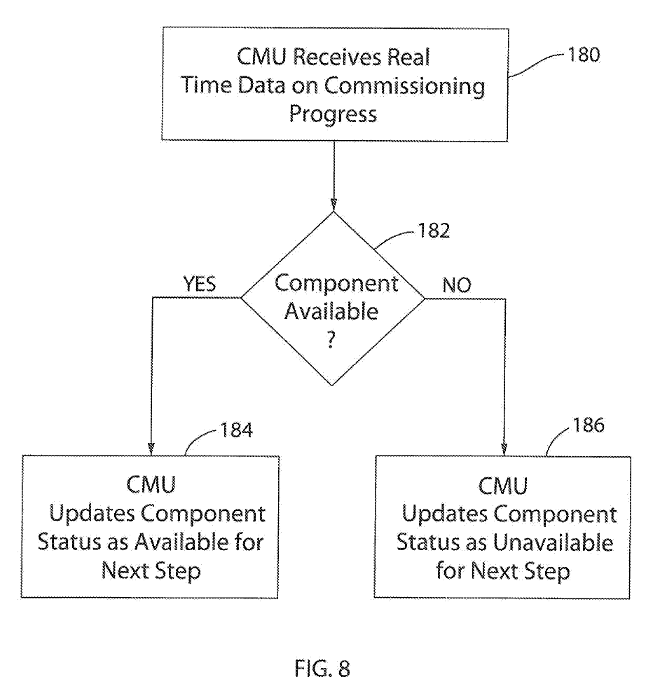

The commissioning system 10 gives the commissioning manager 105 the ability to indicate to the technicians 75 whether the components 77 in a specific area of the facility 70 are available to be checked. With reference to FIG. 8, the commissioning manager unit 50 receives real time, or near-real time, information on the progress of commissioning the system, as shown in step 180. Based on the information received, the commissioning manager may decide whether a component 77 is available for the next step in the commissioning process, as shown in step 182. For example, the commissioning manager 105 can identify the reactor and distillation column areas as not being available for static checks until the electrical connections in the areas are completed. By indicating that the selected areas (or components 77 in the selected areas) are unavailable for further commissioning steps, when the technician searches for instruments to test, the instruments that have been marked unavailable for testing will not show up in the technician's list. Based on the exemplary report of FIG. 15, the commissioning manager 105 can place a freeze on further testing in the reactor and distillation column areas, so that the technicians 75 can focus their energies on completing, the testing for the boiler and the effluent area. This report gives the commissioning manager 105 significant ability to monitor the progress of the commissioning process and place temporary freezes on testing in areas where there are bottle necks, to allocate resources (i.e., technicians 75) to areas where they can be most useful by indicating specific areas or components 77 as being available for testing (step 184) or as being unavailable for testing (step 186).

The freezes are lifted once the reason for the bottle neck has been determined and resolved. For example, if a freeze for the technicians 75 is placed on testing the distillation column pending the completion of the electrical connection of components for the distillation column, the freeze can be lifted once it is determined that the electrical connections have been made. When a freeze is placed on an area, the components 77 affected by the freeze will not show up on a list of available components to check when a technician does a “Near Me” search 306. Because components 77 unavailable or not otherwise ready for testing will not be presented to the technician 75 in his/her search for components 77, the technician will not waste time finding components that are unavailable for testing. However, the “frozen” components 77 will be visible to the commissioning manager 105, so that the manager can uncheck/unfreeze them when the components 77 are ready to be checked. Further, the commissioning manager 105 may instruct mechanics and/or electricians to make the required connections such that components 77 will become available for testing. It is contemplated that one of the reports available in the reports menu 309 could be a “Frozen” components report.

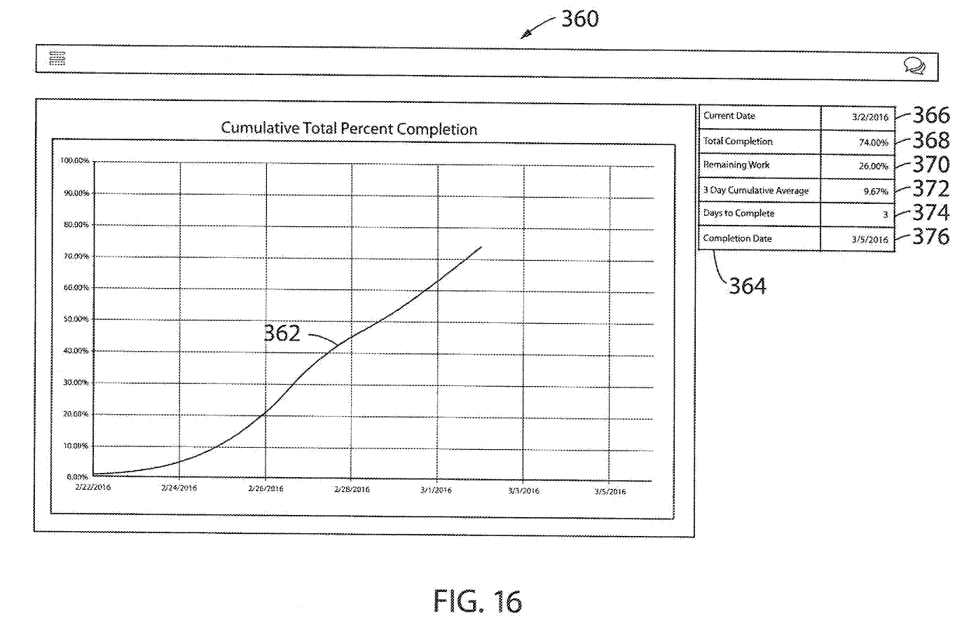

FIG. 16 shows an exemplary report 360 for “Cumulative Total Percentage Completion” which may be selected by option 315 in the reports menu 309. The report plots the cumulative total percent completion of the commissioning project on a daily basis. As seen in the illustrative plot 362, testing began on Feb. 22, 2016. Since about the second day of testing, the commissioning project has experienced a consistent rate of testing, and at the 10th day (i.e., Mar. 2, 2016) the commissioning project is about 74% complete. At the upper right of the “Cumulative Total Percentage Completion” report 360, the display includes a table 364 showing the current date 366, the total percentage completion 368, the percentage of work remaining in the project 370, a three-day cumulative work average 372, days remaining to completion 374, and the completion date 376. This plot 362 and its associated table 364 give the commissioning manager 105 the status of the overall project. With the 3-day cumulative average 372, the commissioning manager 105 is provided with a running average of the amount of work completed on a daily basis. Based on this, the commissioning manager 105 can make a determination whether the project is ahead of schedule, behind schedule or on schedule. In the illustrative graph of FIG. 16, there are 3 days remaining to schedule completion, 26% of the project remains to be completed, and the 3-day cumulative average is 9.67%/day. Based on this, the commissioning manager 105 can determine that, as long as the amount of work completed each day remains substantially the same, the commissioning project will be completed on the designated completion date. If the information indicated that the project was behind schedule, the commissioning manager 105 could then determine what steps would be necessary to better ensure that the project will end on schedule. Such steps could include, for example, employing additional technicians, authorizing overtime, etc. The information contained in the “Cumulative Total Percentage Completion” report 360 thus provides for early detection of the possibility that the target completion date will be missed, and will provide the commissioning manager 105 time to correct the issue before it is too late. The plot 362 of FIG. 16 is for the overall project. The commissioning system can also produce similar plots for the individual areas or loops in the facility.

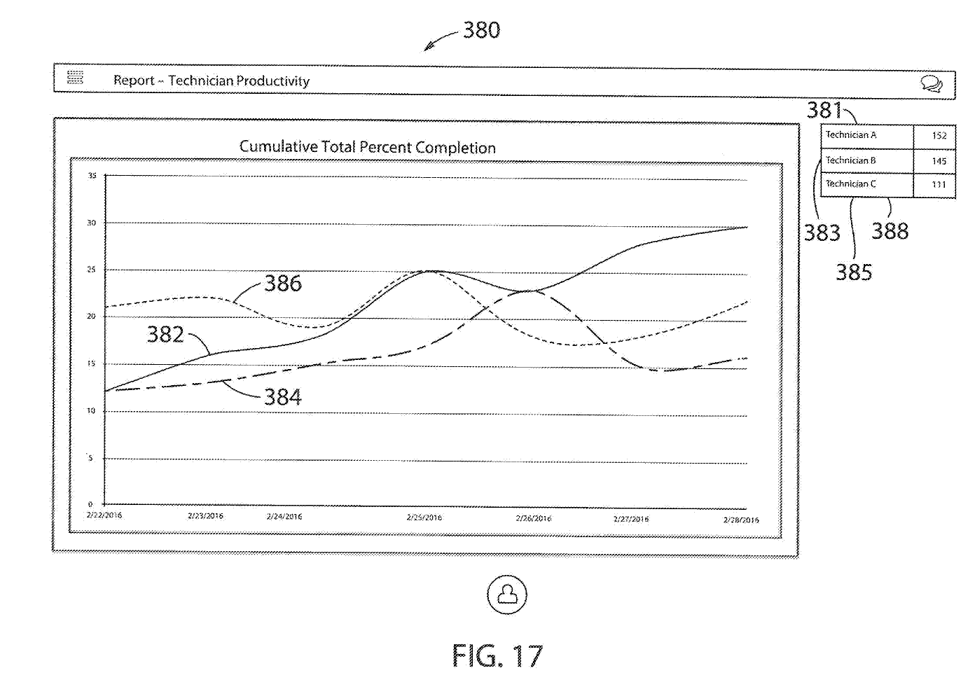

As discussed above, the commissioning system 10 records in the database 30 the technician 75 who completed a check sheet (such as a pre-dynamic check sheet) as well as the date and time the check sheet was completed. The progress of individual technicians 75 can be monitored as well. Referring next to FIG. 17, a “Technician Pre-Dynamic Checks by Day” report 380 may be selected by option 319 in the reports menu 309. The “Technician Pre-Dynamic Checks by Day” report 360 includes multiple plots 382, 384, 386, where each plot corresponds to a technician. The first plot 382 corresponds to Technician A 381, the second plot 384 corresponds to Technician B 383, and the third plot 386 corresponds to Technician C 385. Bach plot indicates the number of pre-dynamic checks made by the three technicians daily for a seven-day period. In the upper right, the report 380 includes a table 388 that displays the total number of checks made by each of the technicians for the plotted period (i.e., the 7-day period). This information will give the commissioning manager 105 information regarding the productivity of each of the technicians 381, 383, 385, and can provide insight as to whether a technician is having difficulty. For example, if one technician 381, 383, 385 is consistently underperforming relative to another technician 381, 383, 385, the commissioning manager 105 can investigate and determine if the technician needs any particular assistance. Also, if a technician's productivity suddenly drops, it could be an indication that the technician is not feeling well or is consistently encountering barriers to completion. These changes in productivity can be a guide to the overall progress of the commissioning project, and can be used to help the commissioning manager 105 in making staffing decisions. As can be appreciated, similar graphs can be generated for Pre-Static, Static, and Final Dynamic checks, as well as overall checks.

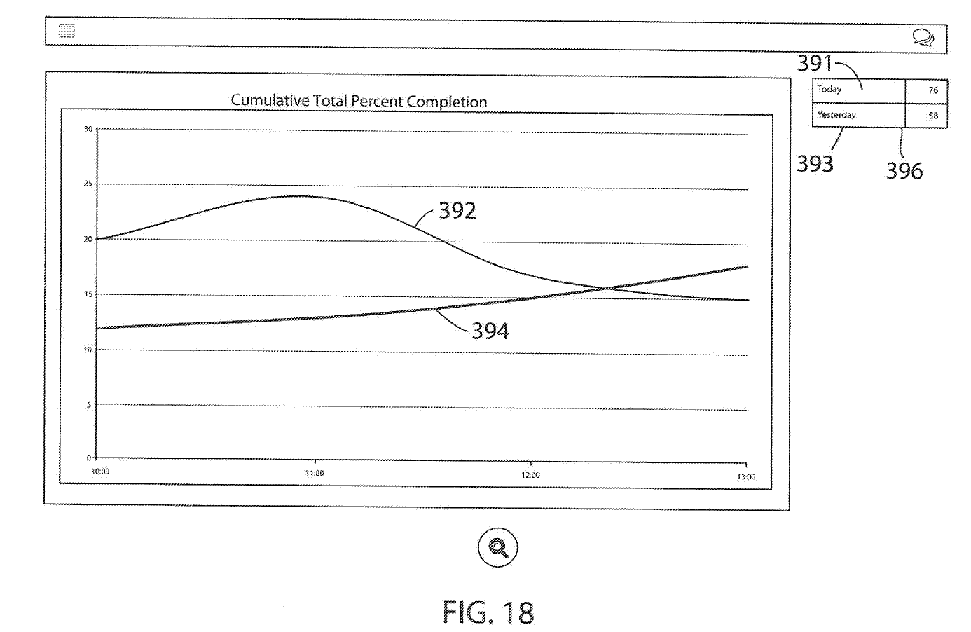

Because the completion date and time of the check sheets is recorded in the database 30, the commissioning system 10 can also track the number of checks completed per day for the facility 70 as a whole or for particular areas within the facility 70. A “Productivity Compare” report 390, as shown in FIG. 18, plots and compares the number of checks (pre-dynamic checks) made on an hourly basis for the same time period of two consecutive days for the boiler area. A first plot 392 presents the number of checks completed each hour on a first day 391 (e.g., today), and a second plot 394 presents the number of checks completed each hour on a second day 393 (e.g., yesterday). A table 396 at the upper right shows the total number of cheeks made over the plotted time period for each of the two days.

According to the exemplary plots, the overall number of checks made “Today” is about 30% greater than the number of checks made “Yesterday”. Further, it can be seen that “Yesterday,” the number of checks made each hour increased. In contrast the number of cheeks made each hour “Today,” peaked around 11:00 and then dropped off. This graph can be made for the project overall, or for individual areas in the facility. Certain changes would be expected. For example, in this graph, the increasing rate of check completion from “Yesterday” through about 11:00 “Today” could be due to more components 77 having their static checks completed and, thus, becoming ready for their pre-dynamic checks. Further, the drop in the number of checks made after 11:00 “Today” could indicate the pre-dynamic test stage of the project is ending. Depending on the type of changes that are occurring and comparing this report 390 with the other reports, the commissioning manager 105 can determine if there are any issues in completions of any of the testing for any of the areas that need addressing.

The graphs of FIGS. 17 and 18 illustratively show pre-dynamic check information. It will be appreciated that corresponding graphs can be made for pre-static checks, static checks, and final dynamic checks, as well as for the commissioning process as a whole.

As various changes could be made in the above constructions without departing from the scope of the invention, it is intended that all matter contained in the above description or shown in the accompanying drawings shall be interpreted as illustrative and not in a limiting sense. Although described with respect to the startup of a facility, it will be appreciated that the system can also be used when commissioning turn-arounds or other maintenance conditions, upgrades, etc.

It should be understood that the invention is not limited in its application to the details of construction and arrangements of the components set forth herein. The invention is capable of other embodiments and of being practiced or carried out in various ways. Variations and modifications of the foregoing arc within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A method for commissioning a production facility, the production facility including at least one control loop, wherein the control loop has a plurality of components and each component has a machine readable identification (ID) tag containing a component specific identifier, the method comprising the steps of:
reading the ID tag on a component to be commissioned with a technician unit to obtain the component specific identifier;
transmitting the component specific identifier from tile technician unit to a control unit, wherein the control unit includes a component database storing data corresponding to each of the plurality of components in the production facility;
receiving data corresponding to the component to be commissioned from the control unit as a function of the component specific identifier;
generating a loop folder on the technician unit responsive to the data received from the control unit;
displaying the loop folder on a display of the technician unit;
storing commissioning data entered into the technician unit, wherein the commissioning data corresponds to commissioning of the component having the component specific identifier, wherein the commissioning data includes a current status of the component arid a timestamp corresponding to entering of the commissioning data;
transmitting the commissioning data from the technician unit to the control unit, wherein the control unit is configured to store the commissioning data in the component database;
transmitting a request for a report on a status of commissioning the production facility from a commissioning manager unit to the control unit;
generating the report as a function of the commissioning data in the component database; and
displaying the report on the commissioning manager unit.

2. The method of claim 1 further comprising an initial step of transmitting a list of components available for testing to the technician unit from the control unit.

3. The method of claim 2 further comprising an initial step of transmitting a request from the technician unit for the list of components, wherein the request includes a current location of the technician unit and the list includes components within a predetermined distance of a current location of the technician unit.

4. The method of claim 2 wherein at least a portion of the components are identified as unavailable in the database and wherein the list of components does not include any component in the portion of the components identified as unavailable.

5. The method of claim 2 wherein the step of reading the ID tag on the component to be commissioned includes one of the following: electronically reading the ID tag using an input device on the technician unit; manually entering the component specific identifier into the technician unit; and selecting one of the components from the list of components.

6. The method of claim 2 wherein the technician unit includes a position locator and the technician unit transmits a current location of the technician unit when reading the ID tag along with the component specific identifier to the control unit.

7. The method of claim 6 wherein the technician unit includes a mapping application and is configured to display one of a map and a schematic layout of an area near the technician unit and is further configured to overlay a location of each of the components in the list of components on the map or the schematic layout.

8. The method of claim 1 wherein the report shows a real or near real-time status of one of a commissioning status of a selected area of the production facility, a completion percentage for commissioning the production facility, an expected completion time for commissioning the production facility, and a performance of each technician commissioning the production facility.

9. A method for commissioning a production facility, the production facility including at least one control loop, wherein the control loop has a plurality of components and each component has a machine readable Identification (ID) tag containing a component specific identifier, the method comprising the steps of:
obtaining a current location of a technician unit used for commissioning the plurality of components from a position locator in the technician unit;
transmitting the current location from the technician unit to a control unit, wherein the control unit includes a component database storing data corresponding to each of the plurality of components in the production facility;
receiving a list of components at the technician unit from the control unit, wherein the list of components includes each of the plurality of components that arc within a predetermined distance of the current location of the technician unit;
reading the ID tag on one of the plurality of components that are within the predetermined distance of the current location to obtain the component specific identifier;
transmitting the component specific identifier which was read from the ID tag from the technician unit to the control unit;
receiving data corresponding to the component to be commissioned from the control unit as a function of the component specific identifier;
generating a loop folder on the technician unit responsive to the data corresponding to the component received hum the control unit;
displaying the loop folder on a display of the technician unit;
storing commissioning data entered into the technician unit, wherein the commissioning data corresponds to commissioning of the component having the component specific identifier and wherein the commissioning data includes a current status of the component and a timestamp corresponding to entering of the commissioning data; and
transmitting the commissioning data from the technician unit to the control unit, wherein the control unit is configured to store the commissioning data in the component database.

10. The method of claim 9 wherein the technician unit includes a mapping application and is configured to display one of a map and a schematic layout of an area near the technician unit and is further configured to overlay a location of each of the components in the list of components on the map or the schematic layout.

11. The method of claim 9 wherein the step of reading the ID tag on one of the plurality of components includes one of the following: electronically reading the ID tag using an input device on the technician unit; manually entering the component specific identifier into the technician unit; and selecting one of the plurality of components from a list of components displayed on the technician unit.

12. The method of claim 9 further comprising the steps of:
transmitting a request for a report on a status of the commissioning process from a commissioning manager unit to the control unit;
generating the report as a function of the commissioning data in the component database; and
displaying the report on the commissioning manager unit.

13. The method of claim 12 further comprising the step of controlling a schedule corresponding to commissioning the production facility as a function of the report.

14. The method of claim 13 wherein the step of controlling the schedule corresponding to commissioning the production facility as a function of the report includes identifying at least a portion of the components as being unavailable on the commissioning manager unit, wherein the list of components transmitted to the technician unit does not include a component from the portion of components identified as being unavailable.

15. A commissioning system for a production facility, the production facility including at least one control loop, wherein the control loop has a plurality of components and each component has a machine readable Identification (ID) tag containing a component specific identifier, the commissioning system comprising:
at least one portable technician unit having an input device, a display, a communication interface, and a position locator, wherein:
the input device is configured to obtain the component specific identifier from the ID tag on a component to be commissioned,
the position locator is configured to generate a signal corresponding to a current position of the technician unit,
the communication interface is configured to transmit the component specific identifier and the signal corresponding to the current position of the technician unit to a control unit, wherein the control unit includes a component database storing data corresponding to each of the plurality of components in the production facility,
the communication interface is configured to receive data from the control unit, wherein the data corresponds to the component to he commissioned,
the display is configured to display a loop folder with the data received from the control unit,
the input device is further configured to receive commissioning data from a technician using the technician unit, and
the communication interface is further configured to transmit the commissioning data to the control unit;
a commissioning manager unit having an it put device, a display, and a communication interface, wherein:
the input device is configured to receive a request for a report including at least a portion of the commissioning data,
the communication interface is configured to receive at least the portion of the commissioning data from the control unit, and
the display is configured to provide a visual indication of the report to a user of the commissioning manager unit.

16. The electronic commissioning system of claim 15 wherein the technician unit and the commissioning manager unit are each a portable computing device.

17. The electronic commissioning system of claim 16 further comprising a server, wherein the control unit executes on the server.

18. The electronic commissioning system of claim 15 wherein the technician unit requests from the control unit a list of the plurality of components within a predetermined distance of the technician unit.

19. The electronic commissioning system of claim 18 wherein the technician unit is configured to execute a mapping application, wherein the mapping application displays one of a map and a schematic layout of an area near the technician unit and is further configured to overlay a location of each of the components within the predetermined distance of the technician unit on the map or the schematic layout.

20. The electronic commissioning system of claim 15 further comprising a server, wherein the control unit and the commissioning manager unit each executes on the server.
